(19) United States
(12) Patent Application Publication
(10) Pub. No.: US 2021/0293132 A1
(43) Pub. Date: Sep. 23, 2021

(54) PROCESS FOR REAL TIME GEOLOGICAL LOCALIZATION WITH GREEDY MONTE CARLO

(71) Applicant: SHELL OIL COMPANY, HOUSTON, TX (US)

(72) Inventors: Neilkunal PANCHAL, Houston, TX (US); Sami Mohammed Khair SULTAN, Houston, TX (US); Yizhou XIA, Houston, TX (US)

(21) Appl. No.: 17/264,009

(22) PCT Filed: Jul. 30, 2019
(86) PCT No.: PCT/US2019/044050

§ 371 Date: Jan. 28, 2021

Related U.S. Application Data
(60) Provisional application No. 62/712,548, filed on Jul. 31, 2018.

(51) Int. Cl. E21B 47/026; E21B 7/04; G01V 1/40

(52) U.S. Cl. CPC E21B 47/026; G01V 1/40; E21B 7/04

(57) ABSTRACT

A method of geosteering in a wellbore construction process uses an earth model that defines boundaries between formation layers and petrophysical properties of the formation layers in a subterranean formation. Sensor measurements related to the wellbore construction process are inputted to the earth model. An estimate is obtained for a relative geometrical and geological placement of the well path with respect to a geological objective using a trained greedy Monte Carlo agent. An output action based on the sensor measurement for influencing a future profile of the well path with respect to the estimate.

### FIELD OF THE INVENTION

The present invention relates to the field of geosteering and, in particular, to a process for real time geological localization with greedy Monte Carlo for automating geosteering.

### BACKGROUND OF THE INVENTION

In a well construction process, rock destruction is guided by a drilling assembly. The drilling assembly includes sensors and actuators for biasing the trajectory and determining the heading in addition to properties of the surrounding borehole media. The intentional guiding of a trajectory to remain within the same rock or fluid and/or along a fluid boundary such as an oil/water contact or an oil/gas contact is known as geosteering.

The objective in drilling wells is to maximize the drainage of fluid in a hydrocarbon reservoir. Multiple wells placed in a reservoir are either water injector wells or producer wells. The objective is maximizing the contact of the wellbore trajectory with geological formations that: are more permeable, drill faster, contain less viscous fluid, and contain fluid of higher economical value. Furthermore, drilling more tortuous wells, slower, and out of zone add to the costs of the well.

Geosteering is drilling a horizontal wellbore that ideally is located within or near preferred rock layers. As interpretive analysis is performed while or after drilling, geosteering determines and communicates a wellbore's stratigraphic depth location in part by estimating local geometric bedding structure. Modern geosteering normally incorporates more dimensions of information, including insight from downhole data and quantitative correlation methods. Ultimately, geosteering provides explicit approximation of the location of nearby geologic beds in relationship to a wellbore and coordinate system.

Geosteering relies on mapping data acquired in the structural domain along the horizontal wellbore and into the stratigraphic depth domain Relative Stratigraphic Depth (RSD) means that the depth in question is oriented in the stratigraphic depth direction and is relative to a geologic marker. Such a marker is typically chosen from type log data to be the top of the pay zone/target layer. The actual drilling target or “sweet spot” is located at an onset stratigraphic distance from the top of the pay zone/target layer.

In an article by H. Winkler (“Geosteering by Exact Inference on a Bayesian Network” Geophysics 82:5:D279-D291; September-October 2017), machine learning is used to solve a Bayesian network. For a sequence of log and directional survey measurements, and a pilot well log representing a geologic column, a most likely well path and geologic structure is determined.

There remains a need for autonomous geosteering processes with improved accuracy.

### SUMMARY OF THE INVENTION

According to one aspect of the present invention, there is provided a method of geosteering in a wellbore construction process, the method comprising the steps of: providing an earth model defining boundaries between formation layers and petrophysical properties of the formation layers in a subterranean formation comprising data selected from the group consisting of seismic data, data from an offset well and combinations thereof; comparing sensor measurements related to the wellbore construction process to the earth model; obtaining an estimate from the earth model for a relative geometrical and geological placement of the well path with respect to a geological objective using a trained greedy Monte Carlo agent; and determining an output action based on the sensor measurement for influencing a future profile of the well path with respect to the estimate.

### BRIEF DESCRIPTION OF THE DRAWINGS

The method of the present invention will be better understood by referring to the following detailed description of preferred embodiments and the drawings referenced therein, in which:

FIG. 1 is a flow diagram illustrating one embodiment of the method of the present invention;

FIG. 2 is a flow diagram illustrating another embodiment of the method of the present invention;

FIG. 3 is a flow diagram illustrating a further embodiment of the method of the present invention; and

FIGS. 4A and 4B are graphical representations of geosteering examples.

### DETAILED DESCRIPTION OF THE INVENTION

The present invention provides a method for geosteering in a wellbore construction process. A wellbore construction process can be a wellbore drilling process. The method is advantageously conducted while drilling. The method uses a trained greedy Monte Carlo (GMC) agent. The method is a computer-implemented method.

In accordance with the present invention, an earth model is provided. The earth model defines boundaries between formation layers and petrophysical properties of the formation layers of a subterranean formation. The earth model is produced from data relating to a subterranean formation, the data selected from the group consisting of seismic data, data from an offset well and combinations thereof. Preferably, the earth model is a 3D model.

The earth model may be a static or dynamic model. Preferably, the earth model is a dynamic model that changes dynamically during the drilling process.

Sensor measurements are inputted to the earth model. The sensor measurements are obtained during the wellbore construction process. Accordingly, real-time sensor measurements are made while drilling. In a real-time drilling process, sensors are chosen based on the geological objectives. if the target reservoir and the surrounding medium can be distinguished by a particular measurement, then this measurement will be chosen. Since there is a limit of the telemetry rate, the sample frequency would also be budgeted. Preferably, the sensor measurements are provided as a streaming sequence. The sensors may be LWD sensors, MWD sensors, image logs, 2D seismic data, 3D seismic data and combinations thereof.

The LWD sensor may be, for example, without limitation, a sensor related to a gamma-ray detector, a neutron density sensor, a porosity sensor, a sonic compressional slowness sensor, a resistivity sensor, nuclear magnetic resonance, and the like.

The MWD sensor may be, for example, without limitation, sensors for measuring mechanical properties, inclination, azimuth, roll angles, and the like.

The earth model simulates the earth and then a sensor measurement from the earth. The simulated sensor measurement is then compared to an actual sensor measurement made while drilling.

A well path is selected to reach a geological objective, such as a geological feature (e.g., a fault), a nearby offset well, a fluid boundary and the like. Examples of fluid boundaries may be oil/water contacts, oil/gas contacts, oil/tar contacts, and the like. An estimate for the relative geometrical and geological placement of a well path to reach the geological objective is obtained using a trained GMC agent. An output action based on the sensor measurement for influencing a future profile of the well path is determined with respect to the estimate.

In a preferred embodiment, the relative geometrical and geological placement of the well profile is determined by a relative stratigraphic depth (RSD). In this embodiment, the trained GMC agent matches clustered sensor measurements for the relative stratigraphic depth to a reference measurement with a predetermined set of clusters to discretize the signal for the RSD. A maximum a posteriori probability discretized signal for the RSD is maximized with respect to regularization related to admissible and plausible transitions between adjacent depths and relative geological positions.

A most probable sequence of relative stratigraphic depths is solved by a sampling method selected from the group consisting of mean field, Metropolis-Hastings, Gibbs sampling, Markov chain Monte Carlo and combinations thereof. Preferably, multiple threads of solutions with different initial conditions are solved asynchronously to avoid a local minimum where the most optimal trajectory of the well path is selected.

In a preferred embodiment, the output action of the GMC agent is determined by maximizing the placement of the well path with respect to a geological datum. An objective is maximizing the contact of the wellbore trajectory with geological formations that: are more permeable, drill faster, contain less viscous fluid, and contain fluid of higher economical value. The geological datum can be, for example, without limitation, a rock formation boundary, a geological feature, an offset well, an oil/water contact, an oil/gas contact, an oil/tar contact and combinations thereof.

The steering of the wellbore trajectories is achieved through a number of different actuation mechanisms, including, for example, rotary steerable systems (RSS) or positive displacement motors. The former contains downhole actuation, power generation feedback control and sensors, to guide the bit by either steering an intentional bend in systems known as point-the-bit or by applying a sideforce in a push-the-bit system. PDM motors contain a fluid actuated Moyno motor that converts hydraulic power to rotational mechanical power for rotating a bit. the motor contains a bend such that the axis of rotation of the bit is offset from the centerline of the drilling assembly. Curved boreholes are achieved through circulating fluid through the motor and keeping the drill-string stationary. Curved boreholes are achieved through rotating the drill string whilst circulating such that the bend cycle averages to obtain a straight borehole.

The output action can be curvature, roll angle, set points for inclination, set points for azimuth, Euler angle, rotation matrix quaternions, angle axis, position vector, position Cartesian, polar, and combinations thereof.

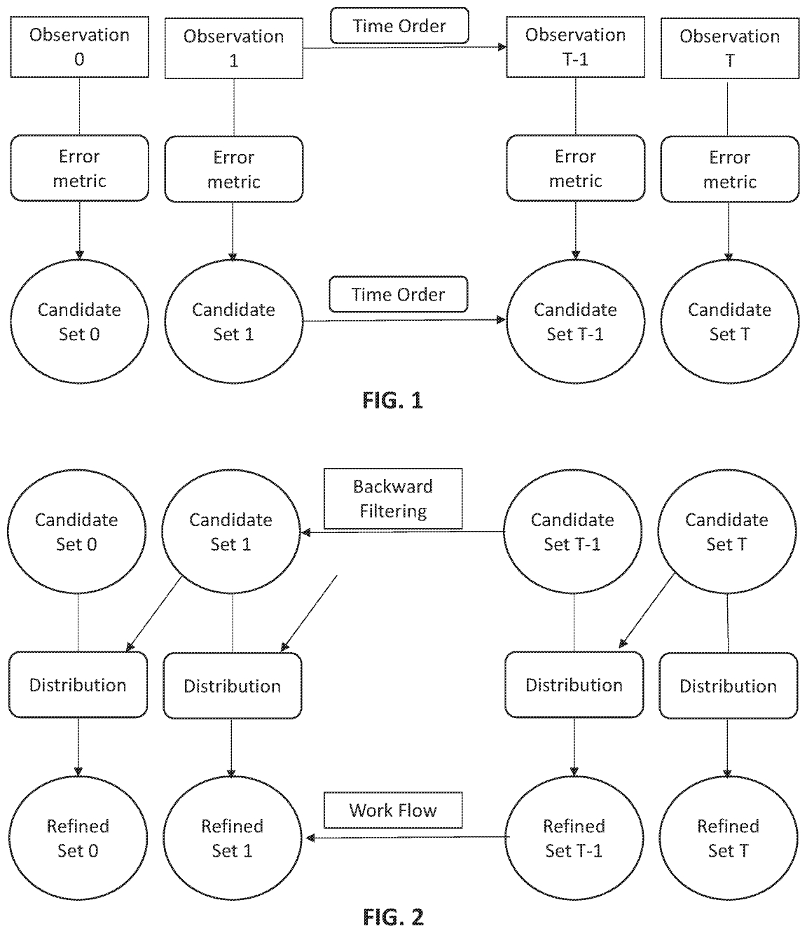

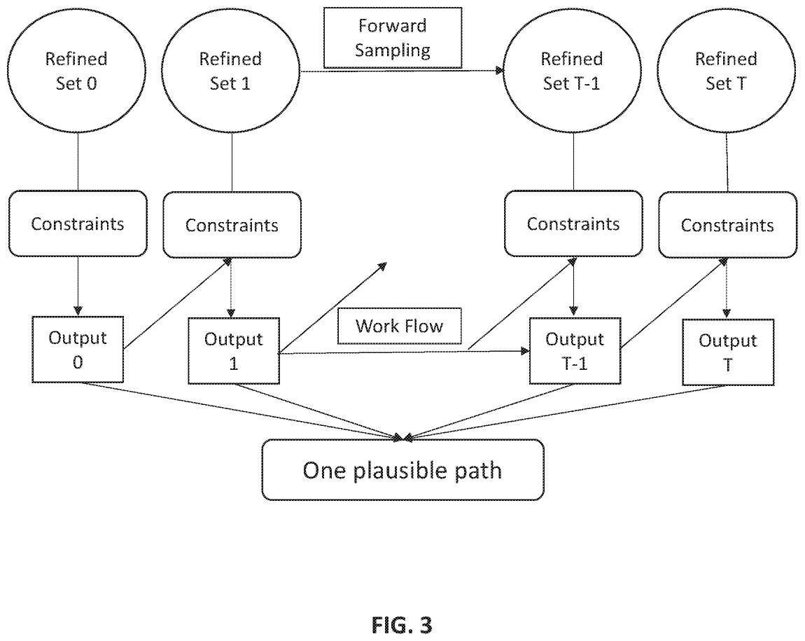

In a preferred embodiment, the trained GMC agent performs the following steps. Steps b)-d) are illustrated in FIG. 1. Steps f) and g) are illustrated in FIGS. 2 and 3, respectively.
a) Discretize the earth model equivalent reference depth indexed signal;
b) Receive an observation of measurements from a system sensor output at depth t;
c) Compare observation from b) with the earth model in a) for all vertical depths obtaining a similarity measure index with the same depth via an error metric;
d) Repeat step c) for all observed values we have and store all plausible candidates into a set for each observation;
e) Filter the sequence from d) based on a predefined error metric obtaining a reduced set of plausible vertical depths in a backward manner (from the most recent observation to the initial state);
f) Given predefined constraint distribution with respect to the earth model and drilling model, the admissible relative geological state transitions from d) is restricted to an adjacent set determined by a distribution.
g) Sample from the distribution f) to generate a predefined set of candidate state transitions with the initial state till most recent observation at t with constraint distribution with constraints.
h) Repeat step g restricted only to the filtered set of admissible states to obtain n admissible interpretations.
i) If there are no admissible interpretations increase the error metric in e) and iterate b)-h).
j) If there are multiple passes: decrease the error metric in d) and iterate b)-h) or modify the state transition distribution (e.g. make it conditional on inclination etc.) or use a metric to sort the interpretations to select the highest cost with respect to a defined cost function e g similarity measure with reference well, smoothness.

To simplify the problem, only discrete stochastic processes are considered. Let {Xₜ, t∈ [symbol] ⁺} be a discrete random process in R^{d}₁ for some integer d₁>0 and {Yₜ, t∈ [symbol] ⁺} be another discrete random process in R^{d}₂ for some integer d₂>0 such that there exists two functions f₁, f₂ such that

Yₜ˜ [symbol] (f₁·f₂(Xₜ),σₜ²

Assumption: the standard deviation 6t may not be constant and may depend on time t.

The probabilistic model described above fits a geosteering problem as follows. Note that inclination and all other information is assumed to be unavailable. In a geosteering scenario, the random variable Xₜ represents the RSD value at time t with d₁=1 and the random variable Yₜ represents the Gamma Ray value at time t with d₂=1. Since information from a typelog is available, the corresponding mathematical meaning is that function f₂ is known. Also, function f₁ is usually assumed to be an unknown affine function such that f₁(x)=a₁x+b₁ for two constants a₁≠0, b₁ for one dimensional case. Indeed, in many cases, f₁ should be a polynomial function with higher order than 1. σₜ may be dependent on time t but σₜ<C for some C>0 (via Bayes method learning from historical data or geostopping). Now gathering with all information above, given a sequence of observations {Yₜ, t∈{1, . . . , n}} and which is a rough estimation of X₁ (the true initial RSD) such that [symbol] ˜ [symbol] (X₁, σ²), we aim to give a estimation of {Xₜ, t∈{1, . . . , n}} (given the best estimation of the sequence of RSDs).

Step 1: Estimation of Function f₁

Since function f₂ is assumed to be known, the first step is to estimate function f₁. One method is to get a good estimation of f₁ from historical data. The second method is to get the estimation of function f₁ from the geostopping method. The third method is to use the information ( [symbol] and Y₁) in time 1 to give a guess.

Once f₁ is estimated, f₁ f₂ is estimated.

Step 2: Possible Xₜ for Each Observation Yₜ

Instead of using Normal distribution as described in Yₜ˜ [symbol] (f₁·f₂ (Xₜ), σₜ², the problem is simplified by assuming that

Yₜ˜unif(f₁·f₂(Xₜ)−c,f₁·f₂(Xₜ)+c)

for some constant c>0 where unif is a uniform distribution.

In the algorithm, the typelog is discretized into 1200 points (this number may vary time to time). Then after step 1 (all Gamma rays are in same scale), for each observation Yₜ (Gamma Ray), a set Aₜ is created to store all the values of X (RSDs in the discretized typelog) such that

f₁·f₂(X)∈[Yₜ−c,Yₜ+c]

Step 3: Backward Filtration for all Sets Aₜ

This step relies on an understanding of the random process Xₜ (RSD). Assume that |Xₜ−Xₜ₋₁|<Z for all integers t≥2 and constant Z>0 (representing no fault in the model). In the algorithm, given sets A₁, . . . , Aₙ, a backward filtration is done for all sets Aₙ₋₁, . . . , A₂. That is, sets Aₙ and Aₙ₋₁ are considered first. Element of Aₙ₋₁ is extracted sequentially and for each element a in Aₙ₋₁, if there exists an element b in Aₙ such that |b−a|<Z, element a is returned back to set Aₙ₋₁−a is deleted otherwise. The process is repeated until all elements in set A₂ have been checked. Set A₁ can be checked here—this is user-defined.

Step 4: Generate Plausible Paths

Optionally, all plausible paths can be generated. In this case, one sample path is generated. First, one element [symbol] is randomly selected from A₁; then any element b satisfying that |b−\hat{X}₁|<Z in set A₂. This process is repeated to generate a full sequence of RSD. A cost function can be used to determine which path is the most likely sequence of RSD based on experience.

Preferably, the GMC agent is trained using a simulation environment, more preferably using a simulation environment produced in accordance with the method described in “Method for Simulating a Coupled Geological and Drilling Environment” filed in the USPTO on the same day as the present application, as provisional application U.S. 62/712,490 filed 31 Jul. 2018, the entirety of which is incorporated by reference herein.

For example, the GMC agent may be trained by (a) providing a training earth model defining boundaries between formation layers and petrophysical properties of the formation layers in a subterranean formation comprising data selected from the group consisting of seismic data, data from an offset well and combinations thereof, and producing a set of model coefficients; (b) providing a toolface input corresponding to the set of model coefficients to a drilling attitude model for determining a drilling attitude state; (c) determining a drill bit position in the subterranean formation from the drilling attitude state; (d) feeding the drill bit position to the training earth model, and determining an updated set of model coefficients for a predetermined interval and a set of signals representing physical properties of the subterranean formation for the drill bit position; (e) inputting the set of signals to a sensor model for producing at least one sensor output and determining a sensor reward from the at least one sensor output; (f) correlating the toolface input and the corresponding drilling attitude state, drill bit position, set of model coefficients, and the at least one sensor output and sensor reward in the simulation environment; and (g) repeating steps b)-f) using the updated set of model coefficients from step d).

The drilling model for the simulation environment may be a kinematic model, a dynamical system model, a finite element model, and combinations thereof.

### Example

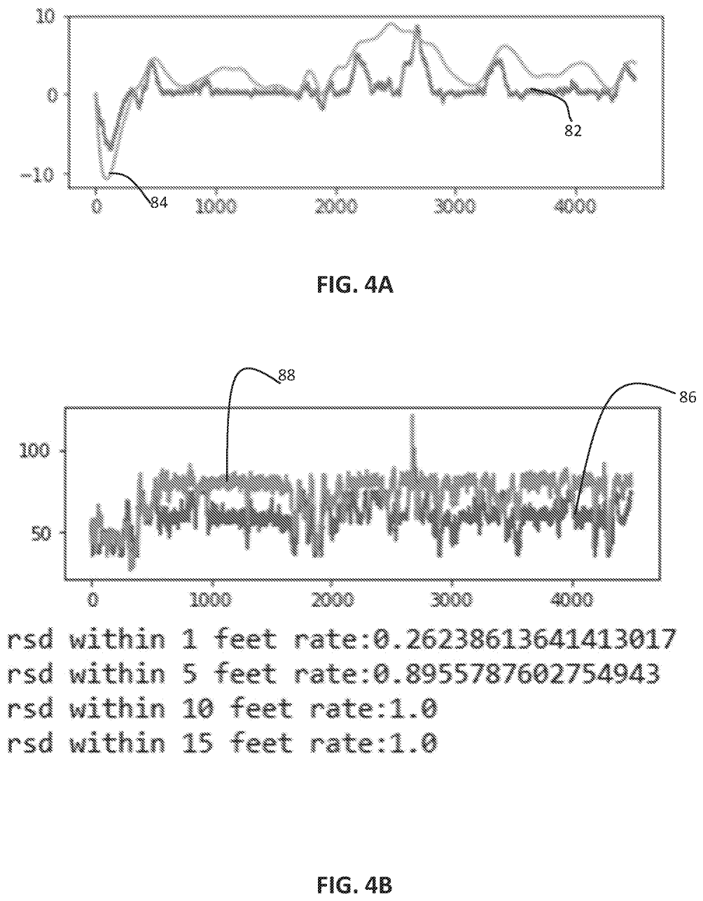

The method of the present invention was tested by comparing a fitted RSD 82 to a true RSD 84 in FIG. 4A. FIG. 4B illustrates a fitted gamma-ray 86 measurement as compared to an observed gamma-ray 88 measurement.

This example demonstrates that the GMC method shows a good consistency for sensor values and illustrates how the GMC method for formation interpretation can be applied even if inclination is not available.

While preferred embodiments of the present disclosure have been described, it should be understood that various changes, adaptations and modifications can be made therein without departing from the spirit of the invention(s) as claimed below.

1. A method of geosteering in a wellbore construction process, the method comprising the steps of:
providing an earth model defining boundaries between formation layers and petrophysical properties of the formation layers in a subterranean formation comprising data selected from the group consisting of seismic data, data from an offset well and combinations thereof;
comparing sensor measurements related to the wellbore construction process to the earth model;
obtaining an estimate from the earth model for a relative geometrical and geological placement of the well path with respect to a geological objective using a trained greedy Monte Carlo agent; and
determining an output action based on the sensor measurement for influencing a future profile of the well path with respect to the estimate.

2. The method of claim 1, wherein the earth model is a static model.

3. The method of claim 1, wherein the earth model is a dynamic model that changes dynamically during the drilling process.

4. The method of claim 1, wherein the sensor measurements are provided as a streaming sequence.

5. The method of claim 1, wherein the sensor measurements are measurements obtained from sensors selected from the group consisting of gamma-ray detectors, neutron density sensors, porosity sensors, sonic compressional slowness sensors, resistivity sensors, nuclear magnetic resonance, mechanical properties, inclination, azimuth, roll angles, and combinations thereof.

6. The method of claim 1, wherein the greedy Mont Carlo agent is trained in a simulation environment.

7. The method of claim 6, wherein the simulation environment is produced by a training method comprising the steps of:
a) providing a training earth model defining boundaries between formation layers and petrophysical properties of the formation layers in a subterranean formation comprising data selected from the group consisting of seismic data, data from an offset well and combinations thereof, and producing a set of model coefficients;
b) providing a toolface input corresponding to the set of model coefficients to a drilling attitude model for determining a drilling attitude state;
c) determining a drill bit position in the subterranean formation from the drilling attitude state;
d) feeding the drill bit position to the training earth model, and determining an updated set of model coefficients for a predetermined interval and a set of signals representing physical properties of the subterranean formation for the drill bit position;
e) inputting the set of signals to a sensor model for producing at least one sensor output and determining a sensor reward from the at least one sensor output;
f) correlating the toolface input and the corresponding drilling attitude state, drill bit position, set of model coefficients, and the at least one sensor output and sensor reward in the simulation environment; and
g) repeating steps b)-f) using the updated set of model coefficients from step d).

8. The method of claim 7, wherein the drilling attitude model is selected from the group consisting of a kinematic model, a dynamical system model, a finite element model, and combinations thereof.

9. The method of claim 1, wherein the output action is determined by maximizing the placement of the well path with respect to a geological datum.

10. The method of claim 9, wherein the geological datum is selected from the group consisting of a rock formation boundary, a geological feature, an offset well, an oil/water contact, an oil/gas contact, an oil/tar contact and combinations thereof.

11. The method of claim 1, wherein the output action is selected from the group consisting of curvature, roll angle, set points for inclination, set points for azimuth, Euler angle, rotation matrix quaternions, angle axis, position vector, position Cartesian, polar, and combinations thereof.
